(19) United States
(12) Patent Application Publication
(10) Pub. No.: US 2009/0066659 A1
(43) Pub. Date: Mar. 12, 2009

(54) COMPUTER SYSTEM WITH TOUCH SCREEN AND SEPARATE DISPLAY SCREEN

(75) Inventors: JIAN-BO HE, Shenzhen (CN); TSUNG-HAN CHEN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/874,922

(22) Filed: Oct. 19, 2007

(30) Foreign Application Priority Data
Sep. 6, 2007 (CN) 200710201601.9

(51) Int. Cl. G06F 3/041

(52) U.S. Cl. 345/173

(57) ABSTRACT

A computer system includes a main processor, a display device, and a touch screen. The main processor is configured to execute instructions and to carry out operations associated with the computer system. The display device is electronically coupled to the main processor, for displaying a graphical user interface. The touch screen is electronically coupled to the main processor. The touch screen includes at least two modes among a touch-screen keyboard mode, a multi-touch screen mode, and a multi-touch screen plus keyboard mode.

### BACKGROUND

1. Field of the Invention

The present invention relates to a computer system, and more particularly to a touch-screen style computer system.

2. Description of Related Art

Physical keyboards are the most ubiquitous input devices for users to enter data and commands into computers. Typing is a widely known and commonly practiced skill. When digital computing became a reality, physical keyboards having the standard typewriter key layout naturally became the standard input means for a user to enter data into a computer. By typing on a keyboard, a user can enter a larger amount of textual data into the computer quickly.

Touch sensitive displays have also been used for a long time for computer user interface purposes, and are widely used on customer service devices, such as automatic teller machines, where user input options are often limited and simple and the speed of data entry is not a concern.

What is needed, therefore, is a touch-screen style computer system that a user can use with many different functions.

### SUMMARY

A computer system includes a main processor, a display device, and a touch screen. The main processor is configured to execute instructions and to carry out operations associated with the computer system. The display device is electronically coupled to the main processor, for displaying a graphical user interface. The touch screen is electronically coupled to the main processor. The touch screen includes at least two modes among a touch-screen keyboard mode, a multi-touch screen mode, and a multi-touch screen plus keyboard mode.

Other advantages and novel features of the present invention will become more apparent from the following detailed description of an embodiment when taken in conjunction with the accompanying drawings, in which:

### BRIEF DESCRIPTION OF THE DRAWINGS

FIG. 1 is an isometric view of a computer system in accordance with an embodiment of the present invention;

FIG. 2 is an isometric view of the computer system in accordance with another embodiment of the present invention;

FIG. 3 is a schematic functional block diagram of the computer system;

FIG. 4 is a flow chart of functional mode choices of the touch screen;

FIG. 5 is a schematic view of the touch screen used as a touch-screen keyboard;

FIG. 6 is a schematic view of the touch screen used as a touch-screen keyboard plus mouse;

FIG. 7 is a schematic view of the touch screen used as a multi-touch screen;

FIG. 8 is a schematic view of the touch screen used as a multi-touch screen plus keyboard;

FIG. 9 is a flow chart for the operation of a reset function of the touch screen;

FIG. 10 is a flow chart showing a process of adjusting the size of a key;

FIG. 11 is a schematic illustration of an image of a contacted point when the key is touched;

FIG. 12 is a flow chart showing a process of differentiating a motion event from a different touch event on the touch screen;

FIG. 13 a schematic illustration of an image of zooming in on the touch-screen keyboard; and

FIG. 14 is a flow chart for the operation of the touch-screen keyboard self definition.

### DETAILED DESCRIPTION

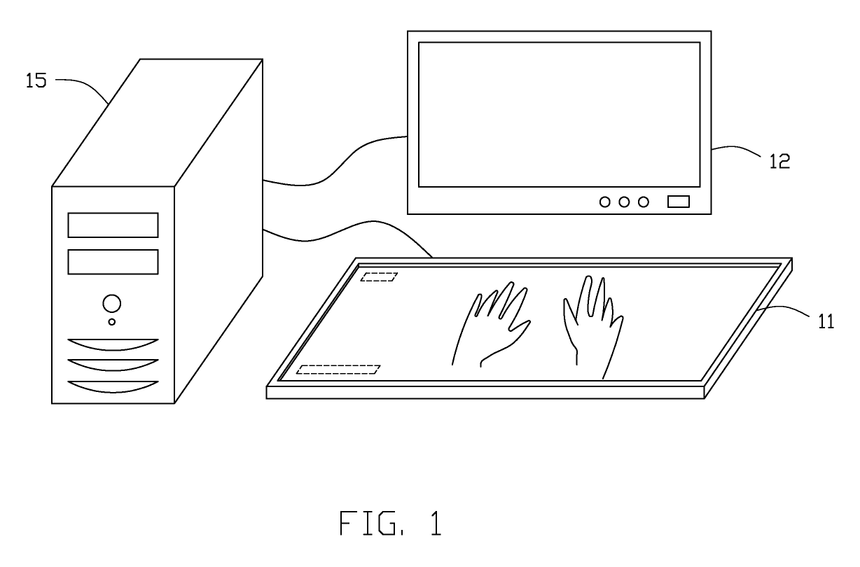

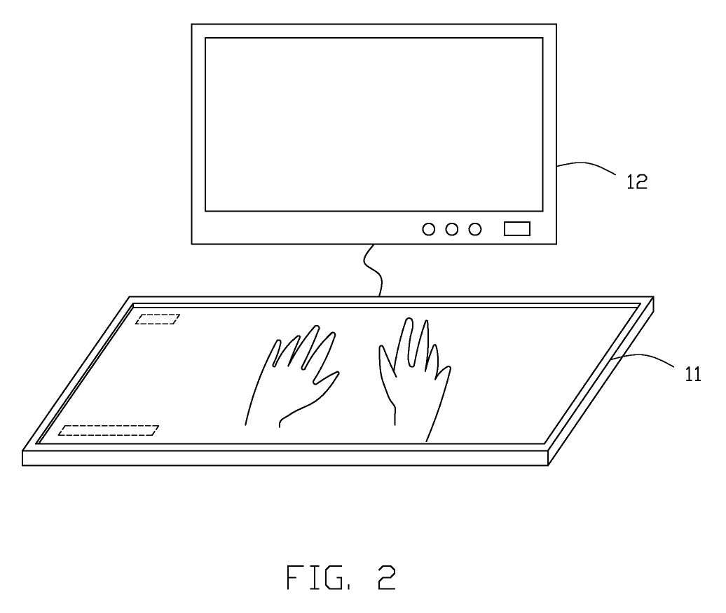

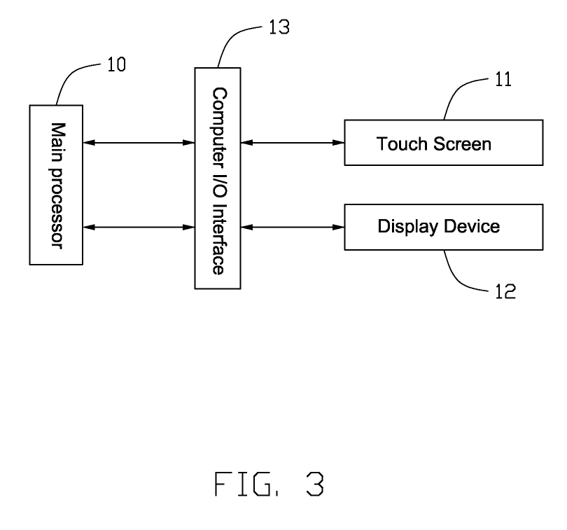

Referring to FIGS. 1, 2, and 3, a computer system includes a main processor 10, a touch screen 11 coupled to the main processor 10, a display device 12 coupled to the main processor 10, and a computer I/O interface 13. The main processor 10 is a DSP (Digital Signal Processor) chip or a SOC (System on a Chip) chip, for executing instructions and carrying out operations associated with the computer system. The main processor 10 can be set in a stand-alone computer 15, as shown in FIG. 1. The main processor 10 also can be set in the touch screen 11, as shown in FIG. 2. The display device 12 is used to display information users input, and a graphical user interface (GUI).

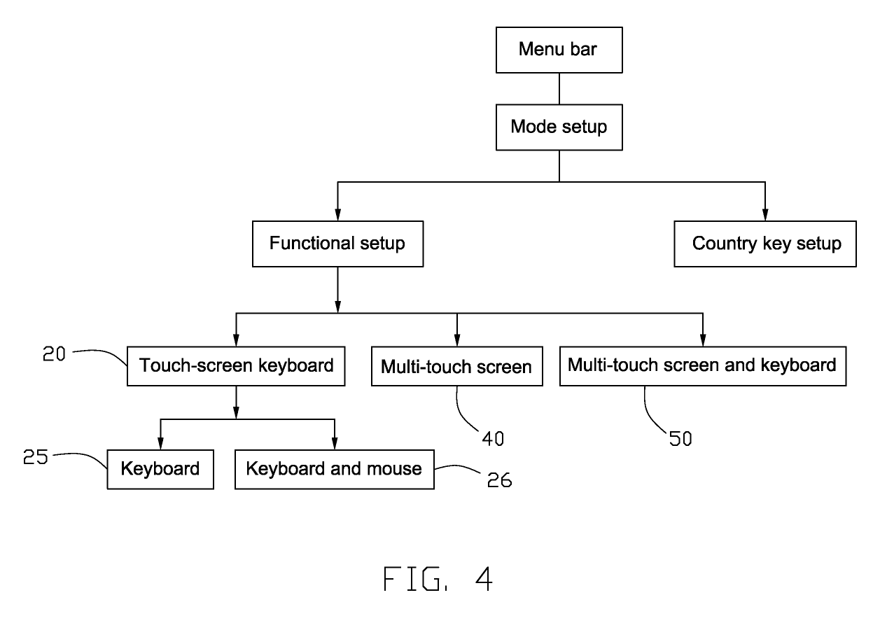

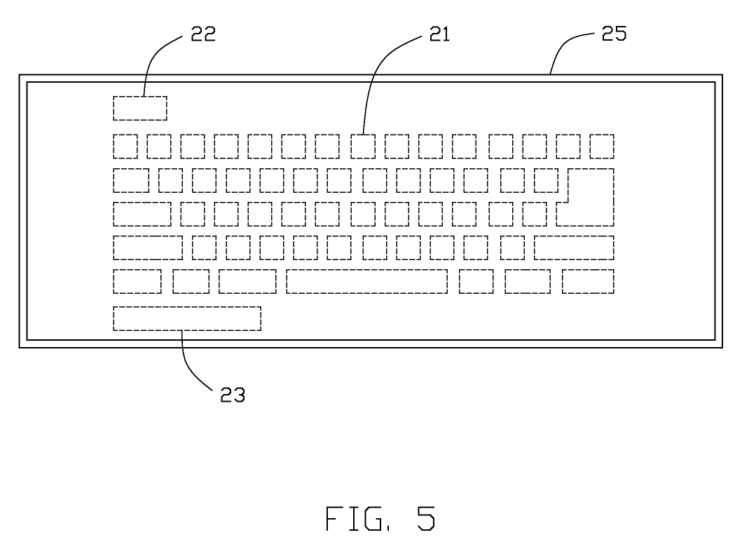

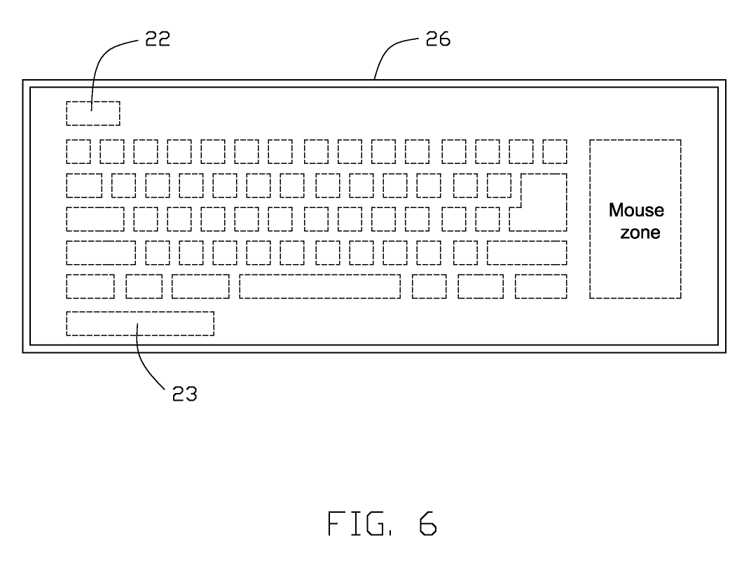

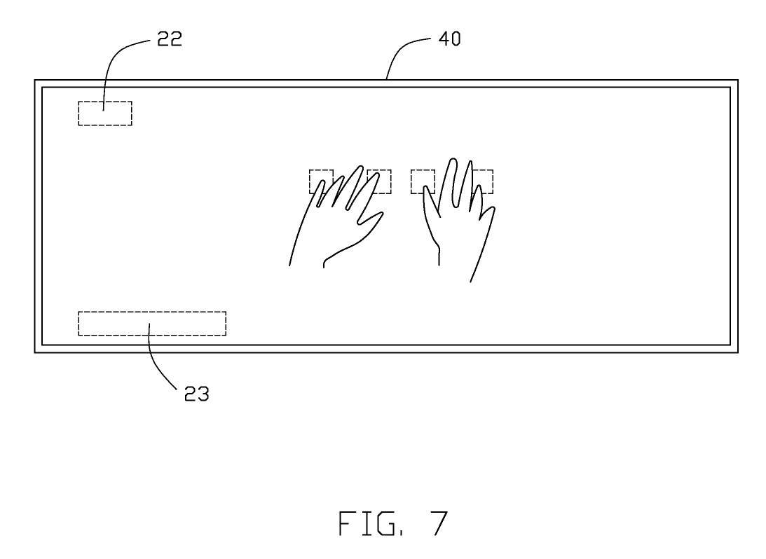

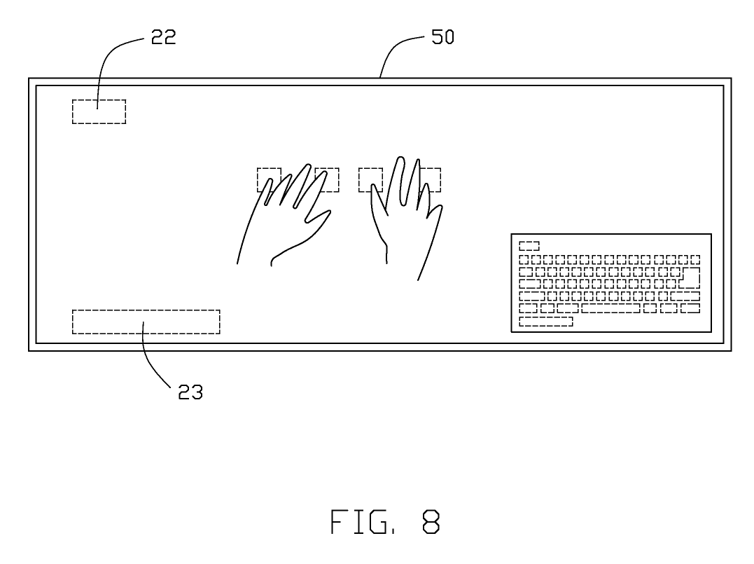

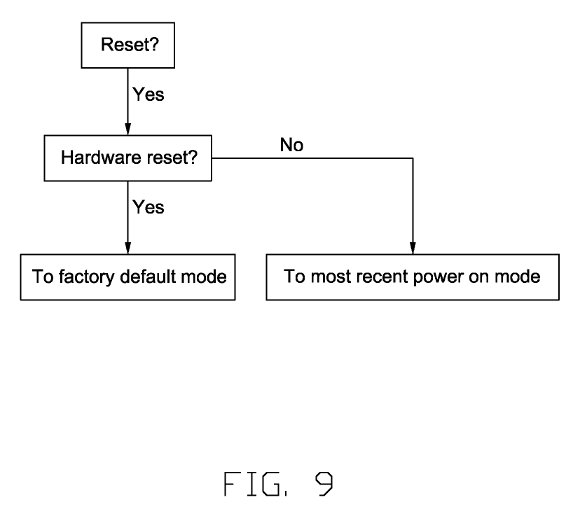

Referring to FIGS. 4 to 9, the touch screen 11 includes a menu bar 23. When a user touches the menu bar 23, the computer system asks for the user to choose one of the functional modes: e.g. a touch-screen keyboard 20, a multi-touch screen 40, or a multi-touch screen plus keyboard 50. Default mode is the touch-screen keyboard 20. The touch-screen keyboard 20 may have a country key setup to choose keyboards of different country of origin. The touch-screen keyboard 20 includes a keyboard mode 25 and a keyboard plus mouse mode 26. The multi-touch screen 40 is configured to detect multiple touches at predetermined locations and near touches (proximal to the predetermined locations) that occur at the same time. The multi-touch screen 40 has same input functions as common input devices (mice, pen-based pads, touch pads, and touch screens). The keyboard mode 25 of the touch-screen keyboard 20 is shown in FIG. 5. The keyboard plus mouse mode 26 of the touch-screen keyboard 20 is shown in FIG. 6. The multi-touch screen 40 is shown in FIG. 7. The multi-touch screen 40 can detect four points touched by fingers at the same time. The multi-touch screen plus keyboard 50 is shown in FIG. 8. Each of the functional modes of the touch screen 11 includes the menu bar 23. As shown in FIG. 9, the touch screen 11 also includes a reset key 22. If the reset key 22 is touched, reset to the factory default mode or to the most recent power on mode occurs, whichever the user has previously chosen for that touch event.

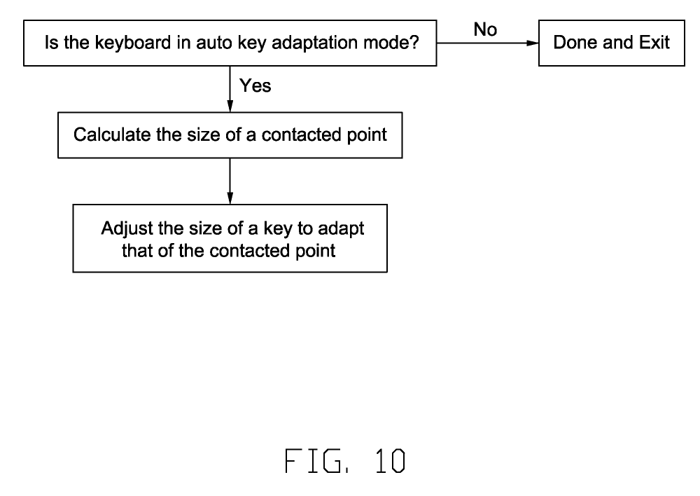

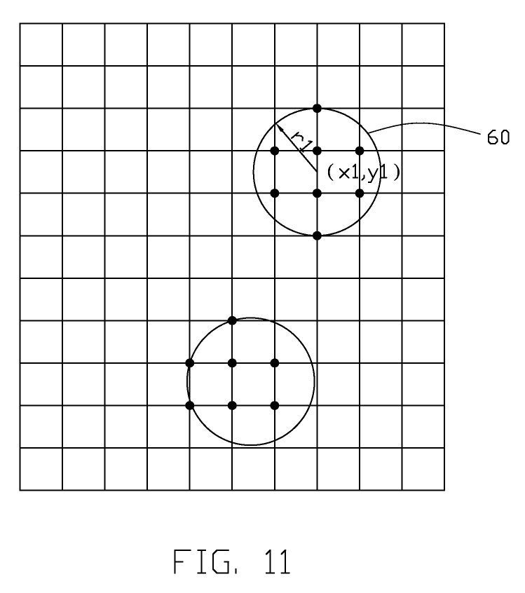

Referring also to FIGS. 10 and 11, the touch-screen keyboard 20 has a plurality of keys 21. The touch screen 11 adjusts the size of the corresponding key 21 to adapt to the size of a touch object (that is an object used for touching the screen). When the touch object touches the screen, it generates a contacted point 60. In auto key adaptation mode, the main processor 10 calculates the size of the contacted point 60. Assuming users use their fingers, as shown in FIG. 11, a circle is the contacted point 60. The touch screen 11 identifies a touch signal. The main processor 10 derives the center (x1, y1) and the radius (r1) of the contacted point 60 from firmware. Thus, the main processor 10 gets the size of the contacted point 60. The touch screen 11 adjusts the size of the key 21 according to the size of the contacted point 60 to adapt to the size of the touch object. Here, it is essential to identify the center (x1, yl) to map it to the defined key values. Identified r1 value serves for at least two purposes. First, if r1 is less than a certain value predefined by the computer system, the touch event is disqualified. Second, r1 effectively indicates the user's finger size.

Compared to usual electrical sampling rates, a touch event is a very slow process. For example, if the touch lasts for 1/10 second, a sampling rate of 1000 Hz will detect the touch for 100 times. Here 100 is a measure of time for the touch event, and will be used to qualify the touch event. If the time period for the touch event is less than 100, the touch event is disqualified. If the time period for the touch event is greater than 100, the touch event is qualified.

In addition, the distances from the center (x1, y1) of the contacted point 60 to all the centers of the defined keys could be derived by the main processor 10, and a minimum value selected from the derived distances. The main processor 10 has a first predefined threshold. If the minimum value is less than the first predefined threshold, then the minimum value key is selected to be the touched one. The first predefined threshold excludes false detect cases where the user has not actually touched anywhere above the predefined key area.

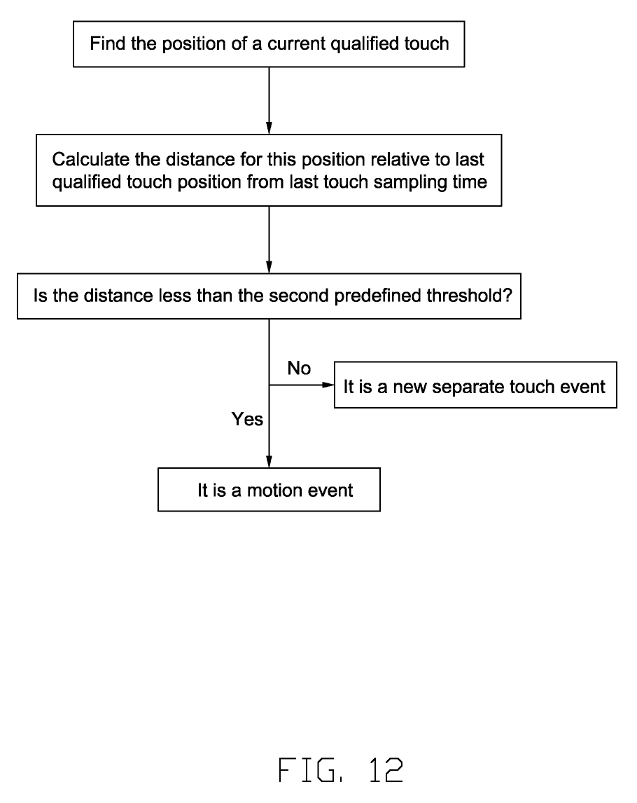

Referring to FIG. 12, when the user touches the screen, the touch screen 11 must differentiate if it is a motion event (where the user's finger has moved while in contact with the touch screen 11) or a new touch event. First, the touch screen 11 finds the position of a current qualified touch. Second, the main processor 10 calculates the distance between this position and the qualified touched position from last touch sampling time. If the distance is less than a second predefined threshold from the main processor 10, it is a motion event from the last touch. Otherwise, it is a new touch event.

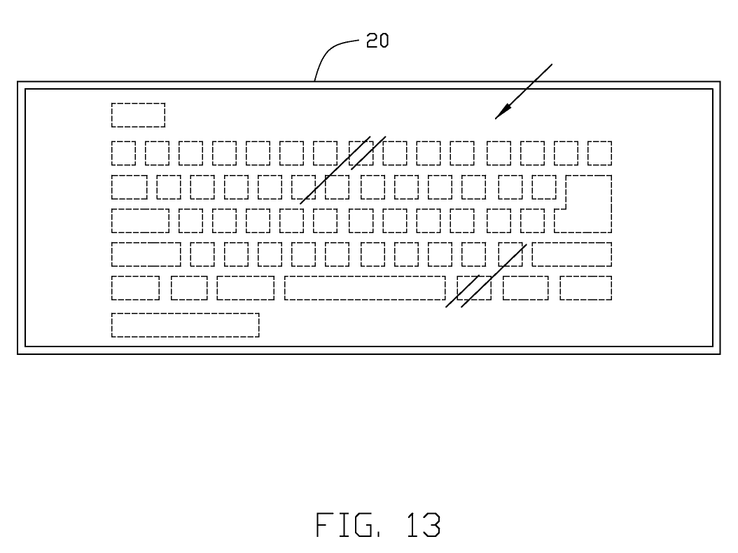

Referring to FIG. 13, the user can zoom in the keyboard 25 image by touching and moving toward the center of the keyboard 25, and zoom out by touching and moving away from the center of the keyboard 25. Thus, the user can change the size of the keys.

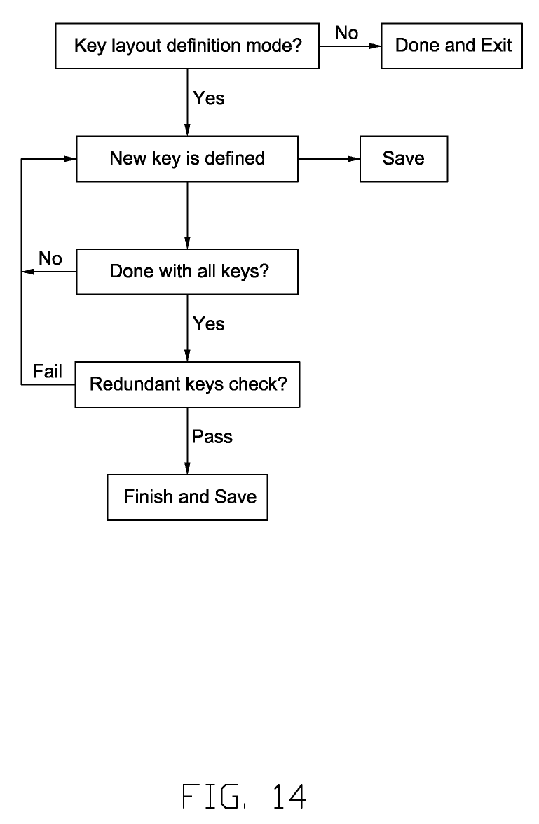

Referring to FIG. 14, the user defines key locations by themselves, and the firmware of the computer system will remember it for its future use. In key layout definition mode, the touch screen 11 displays a blank keyboard. The user touches a blank key location, the main processor 10 asks for the user to input a new symbol. When the user has assigned symbols to all of the keys, the main processor 10 will check if there are any redundant keys. If there are no redundant keys, the computer system will save the results. Otherwise, the user will define new keys again for the redundant ones. Once finished, the user will see a new keyboard as it appears on the display device 12.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A computer system comprising:
a main processor configured to execute instructions and to carry out operations associated with the computer system;
a display device electronically coupled to the main processor, for displaying a graphical user interface; and
a touch screen electronically coupled to the main processor, the touch screen comprising at least two different modes to output information to the main processor, the at least two different modes chosen from a touch-screen keyboard mode, a multi-touch screen mode, and a multi-touch screen plus keyboard mode.

2. The computer system as described in claim 1, wherein the touch screen comprises a menu bar for choosing one mode of the touch screen.

3. The computer system in claim 1, wherein the touch screen comprises a reset key for resetting to the factory default mode or to the most recent power on mode.

4. The computer system as described in claim 1, wherein a circle-shaped contacted point is generated when an object touches the touch screen, the touch screen being configured for adjusting the size of a corresponding key of a keyboard displayed in the touch-screen keyboard mode to adapt to the size of the contacted point.

5. The computer system as described in claim 4, wherein the touch screen is configured for identifying a center coordinate and a radius of the contacted point, getting the size of the contacted point.

6. The computer system as described in claim 1, wherein the main processor defines a predefined threshold, the main processor being configured for calculating a distance between current qualified touch position and last qualified touch position, and determining a touch operation to be a motion event if the distance is less than the predefined threshold, and determining a touch operation to be a new separate touch event if the distance is greater than the predefined threshold.

7. The computer system as described in claim 1, wherein the arrangement of keys of the touch screen is customizable by users, the main processor storing the arrangement of the keys for the users' use.

8. The computer system as described in claim 1, wherein the touch screen is configured for enlarging a keyboard displayed thereon when sensing a user touching the screen and moving toward the center of the keyboard and for reducing the keyboard in size when sensing the user touching the screen and moving away from the center of the keyboard.

9. A computing system comprising:
a display device configured to display a graphical user interface;
a multi-touch screen electronically coupled to the display device, the multi-touch screen being configured to detect touches; and
a main processor electronically coupled to the display device and the multi-touch screen, the main processor being configured for instructing the display device to display one or more GUI elements in response to a touch, and performing actions associated with the GUI elements when touch events are detected relative to the displayed GUI elements.

10. The computer system as described in claim 9, wherein the multi-touch screen is configured to detect multiple touches at predefined locations and near touches that occur at the same time.

11. The computer system as described in claim 9, wherein the multi-touch screen is selectively switchable to a multi-touch screen and keyboard mode or a touch-screen keyboard mode.

12. The computer system as described in claim 11, wherein the multi-touch screen comprises a menu bar for choosing one mode.

13. The computer system as described in claim 9, wherein the multi-touch screen comprises a reset key for resetting to the factory default mode or to the most recent power on mode.

14. The computer system as described in claim 9, wherein the main processor defines a predefined threshold, the main processor being configured for calculating a distance between current qualified touch position and last qualified touch position, and determining a touch operation to be a motion event if the distance is less than the predefined threshold, and determining a touch operation to be a new separate touch event if the distance is greater than the predefined threshold.

15. An apparatus comprising:
a main processor;
a touch screen electronically coupled to the main processor, the touch screen having a touch sensing region for displaying a keyboard for providing input signals in response to manual actuation of the touch screen to the main processor, the size of the keyboard being adjustable; and
a display screen separated from the touch screen, the display screen being electronically coupled to the main processor, for displaying information associated with the input signals.

16. The apparatus as described in claim 15, wherein the size of a key of the keyboard being adjustable in response to the size of a contacted point of the manual stroke actuation on the key of the keyboard.

17. The apparatus as described in claim 16, wherein the touch screen is configured for identifying a center coordinate, a radius of the contacted point, and determining the size of the contacted point.

18. The apparatus as described in claim 15, wherein the size of the keyboard is enlargeable when a user keeps touching the screen and moving toward the center of the touch sensing region, and is reducible when the user keeps touching the screen and moving away from the center of the touch sensing region.
